(19) United States
(12) Patent Application Publication
(10) Pub. No.: US 2005/0077214 A1
(43) Pub. Date: Apr. 14, 2005

(54) Sifting device

(76) Inventor: Franz Anibas, Gleisdorf (AT)

Correspondence Address: WILLIAM COLLARD;COLLARD & ROE, P.C., 1077 NORTHERN BOULEVARD, ROSLYN, NY, 11576, US

(21) Appl. No.: 10/497,331

(22) PCT Filed: Oct. 30, 2002
(86) PCT No.: PCT/AT02/00303

(30) Foreign Application Priority Data
Nov. 29, 2001 (AT) GB M924/2001

(51) Int. Cl. B07B 1/42

(52) U.S. Cl. 209/364

(57) ABSTRACT

A sifting device including a sieve box (1), which is caused to oscillate using a drive (4), as a fundamental oscillation system having essentially horizontal first transverse carriers (1.3) and a supplementary oscillation system (2), attached to the sieve box (1), having essentially horizontal second transverse carriers (2.3), positioned essentially parallel to the first transverse carriers, which are each positioned between two first transverse carriers (1.3) and are connected thereto by stretchable sieve liner strips (3), with, for two sequential transverse carriers, the transverse carrier closer to the feeding side (A) being higher than the subsequent transverse carrier, which is closer to the discharge side (B), with the sifting device having at least two sections, in which the height difference between the centers of gravity of two sequential transverse carriers (1.3, 2.3) is greater in the particular feeding-side section than in the discharge-side section.

The present invention relates to a sifting device according to the preamble of claim 1.

In known sifting devices of this type, sieve mats are used, which are alternately tensioned and relaxed in sections over the sieve surface. This is performed mechanically, for example, two movably implemented oscillation systems, such as sieve boxes, being set in oscillation in relation to one another by an eccentric drive using transverse carriers. The plastic sieve liner strips are connected in this case on one end to the transverse carriers of the first sieve box and, on the other end, to the transverse carriers of the second sieve box. Through the opposing oscillations of the two sieve boxes in relation to one another, and therefore of the particular transverse carriers, the plastic sieve liner strips are alternately tensioned and relaxed. In this way, the product to be sifted is separated into the individual fractions. Through the continuous tensioning and releasing, the sifting covers clean themselves again and again and good separation is possible even with sifting product which is difficult to sift.

However, since the sifting product is not subjected to any acceleration in the conveyance direction of the sifting machine through the oscillation, these sifting machines are also placed at a relatively large slant, so that the sifting product may be conveyed by gravity.

Other known sifting machines include a sieve box having transverse carriers to which an oscillating frame having further transverse carriers is elastically coupled. In these sifting machines, the individual sieve liner strips are connected on one end to the transverse carriers of the sieve box and on the other end to the transverse carriers of the oscillating frame. The sieve box is typically caused to oscillate by being excited by the force of an unbalanced drive and may be referred to as a fundamental oscillation system. Through the oscillation of the sieve box, the oscillating frame elastically coupled to this sieve box is caused to oscillate with corresponding tuning of its oscillation system (mass-spring), and thus represents a supplementary oscillation system. Through the oscillation of the sieve box, the product to be sifted is also subjected to acceleration in the conveyance direction of the sifting machine, so that the product is also conveyed solely by the machine. Slanted placement of the sifting machine is therefore not absolutely necessary, and/or only a significantly lesser slant is necessary.

Through the alternating tensioning and releasing of the sieve mats, which are installed in such sifting devices over the sifting length, these mats clean themselves again and again from jammed grain and caking which is caused by fine, damp sifting product.

Banana sieves represent another embodiment. This refers to sifting devices in which the sieve surface is divided into individual sieve surface sections over the sifting length, each of these sieve surface sections having a different slant within the sifting machine. Such constructions are preferably selected if larger feed quantities are to be separated according to grain size and the cutpoint is relatively close to the largest grain of the feed product. The advantage of such sifting machines is that it is possible to keep the dumping height of the sifting product essentially the same over the entire length of the sifting machine through the. differing slants and thus the different conveyance speeds of the product to be sifted, although there is less and less material to be conveyed and sifted on the sifting plane due to the sifting and the passage of the fine fraction through the screen fabric. Uniform dumping height of the sifting product is of great advantage for effective sifting, since otherwise the particles close to the cutpoint only jump on the sifting plane toward the end of the sifting machine and do not have the possibility of making their way through a mesh of the screen fabric.

The object of the present invention is to combine the advantages of these two sifting devices. This is done in that, in a way known per se, in a sifting machine which is caused to oscillate by an unbalanced drive, for example, a supplementary oscillation system is installed which is excited by the oscillation of the sifting machine and, in this way, sieve mats, which are connected on one end to the sifting machine and on the other end to the second oscillation system, are alternately tensioned and relaxed. In order to now additionally achieve the effect of the banana sieve, the second oscillation system, which is excited by the oscillation of the sifting machine, is implemented according to the characterizing features of claim 1. The sieve surface, which always represents a plane in all known tensioning shaft sifters, is implemented as a curved plane in the new sifting device, particularly as a segment of a cylinder surface. The sieve surface thus has a greater slant on the feeding side than on the discharge side, which, in addition to the known favorable tensioning shaft sieve movement, also provides the advantage of a banana sieve. In addition, it is also possible through this shape of the sieve surface to provide a supplementary oscillation system by installing spring elements, which may be brought into a type of pendulum oscillation through the oscillation of the sifting machine, through which the tensioning shaft sieve effect is achieved very simply. The characterizing features of claims 3 through 11 relate to advantageous embodiments of an oscillation system of this type.

Claim 12 relates to an embodiment of the oscillation exciter which is advantageous in the context of the object of the present invention.

The present invention will now be described in greater detail on the basis of the attached figures.

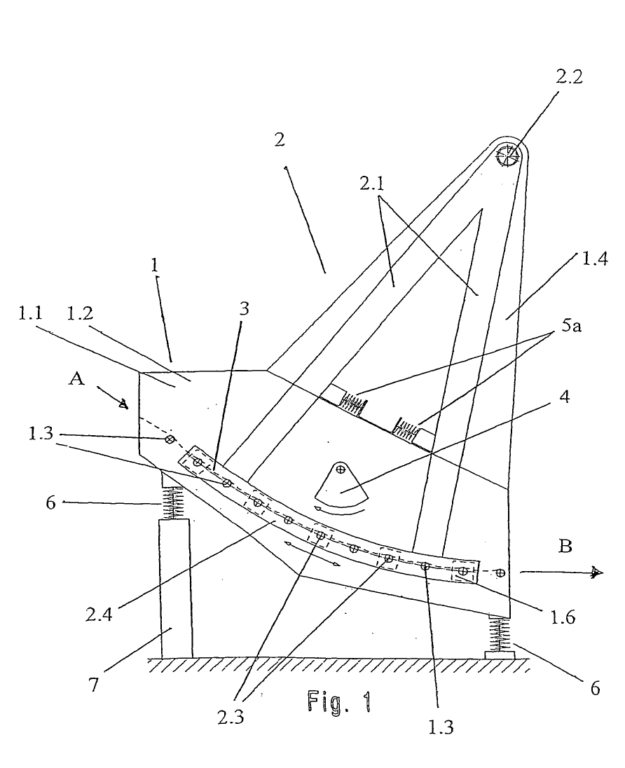

FIGS. 1 through 6 show different embodiments of the coupling of the supplementary oscillation system to the sieve boxes of the fundamental oscillation system in outline and

FIGS. 7 and 8 show different arrangements of decisive components of both oscillation systems in outline.

FIG. 1 schematically shows the construction of such a sifting machine. In this case, the sieve box (1), which includes the sieve faces 1.1, 1.2, between them, and the first transverse carriers 1.3, which connect the sieve faces, is supported via spring elements 6 on brackets. These are caused to oscillate by an unbalanced drive 4. A support device 1.4 is installed on the sieve box, which has a pendulum axle 2.2 (a shaft, for example) for a pendulum-like construction 2 on its upper end. This pendulum-like construction 2 includes the pendulum arms 2.1 and the receiving parts 2.4 for the second transverse carriers 2.3, movable in relation to the sieve box 1, which pass through the sieve boxes through window-like openings 1.6. The transverse carriers 1.3 and 2.3 may be positioned in such a way that they may be understood as surface lines of a cylinder surface whose axis corresponds to the pendulum axle 2.2. The strip-shaped sieve mats 3 are tensioned between the transverse carriers 1.3 and 2.3. Furthermore, spring elements 5a may be installed between the sieve box 1 and the pendulum-like construction 2 in order to be able to influence the amplitude of the pendulum oscillation in relation to the fundamental oscillation of the sieve box 1. Through the oscillating movement of the sieve box 1, the pendulum-like construction 2 is also excited to oscillate and, through suitable selection of the dimensions and/or through the additional installation of spring elements, the amplitude of the pendulum-like construction 2 may be influenced. The sifting device is charged at the feeding side A with sifting product, the unsifted product leaving the sifting device at the discharge side, B.

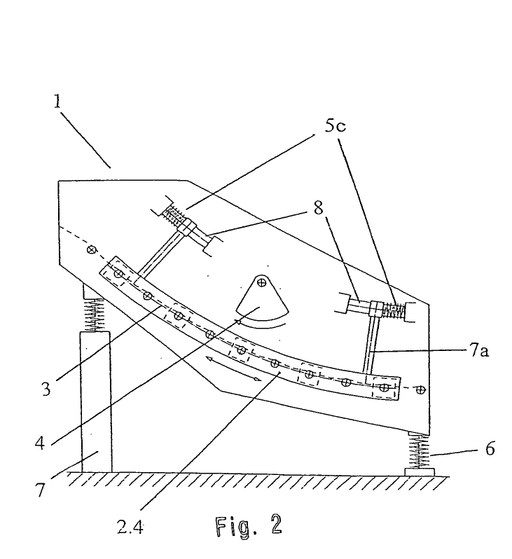

FIG. 2 shows another embodiment of the present invention. In this embodiment, the receiving parts 2.4 are guided in approximately a pendulum motion by leaf springs 5b which are adjusted in relation to one another and are used simultaneously as spring elements for the supplementary oscillation system excited by the oscillation of the sieve box 1.

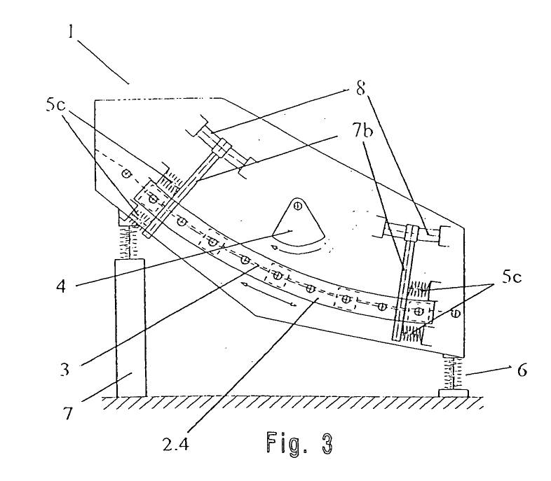

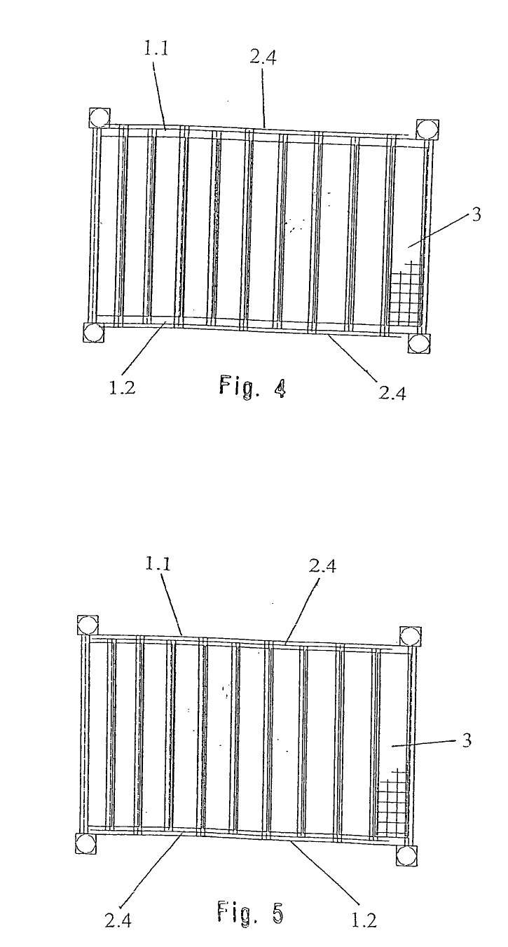

A further embodiment is shown in FIG. 3. In this case, the receiving parts 2.4 are guided in guide elements 8 via spacer elements 7a. In order to obtain an oscillation system in this case, it is necessary to install spring elements 5c on the guide elements or to position them on or near the receiving parts 2.4, as shown in FIG. 4.

A preferred embodiment of the present invention is shown in FIG. 5. It is essentially constructed in that a sieve box 1, including two sieve faces 1.1, 1.2 and, between them, first transverse carriers 1.3, which connect the sieve faces 1.1, 1.2, is supported via spring elements 6 on brackets, which are caused to oscillate by an oscillation exciter 4, such as an unbalanced exciter. Window-like openings 1.6 are provided on the two side faces 1.1, 1.2 of the sieve box 1, through which the second transverse carriers 2.3 pass. These second transverse carriers 2.3 are attached to receiving parts 2.4. The connecting first transverse carriers 1.3 of the sieve box 1 and the second transverse carriers 2.3 may be positioned, for example, in such a way that they may be understood as surface lines of a cylinder. The receiving parts 2.4 are connected to the sieve box via spring elements 5e on spring brackets 1.5, which are positioned fixed on the sieve box 1.

Another embodiment is shown in FIG. 6. In this construction, the receiving parts 2.4 are guided via hinge rods 7c, which are mounted in an articulated way on one end on the sieve box 1 and on the other end on the receiving parts 2.4, so that the possibility for oscillation approximately corresponds to a pendulum oscillation. Furthermore, the receiving parts 2.4 are clamped between consoles 1.5, which are connected fixed to the sieve box 1, via spring elements 5f.

Furthermore, positioning the receiving parts 2.4 either outside (see schematic illustration in FIG. 7) or inside (see FIG. 8) the sieve faces 1.1 and/or 1.2 is provided depending on the separating task. FIG. 9 shows a sifting machine according to FIG. 5, however, instead of the unbalanced exciter 4, a linear oscillator 4.1 of known construction having a double unbalanced drive with opposing unbalanced weights is mounted on the sieve box 1 as the oscillation exciter. The sifting device according to the present invention thus combines the advantages of a tensioning shaft sieve with those of a banana sieve and is especially suitable for sifting products which are difficult to sift.

1. A sifting device including a sieve box (1), which is caused to oscillate using a drive (4), as a fundamental oscillation system having essentially horizontal first transverse carriers (1.3) and a supplementary oscillation system (2), attached to the sieve box (1), having essentially horizontal second transverse carriers (2.3), positioned essentially parallel to the first transverse carriers, which are each positioned between two first transverse carriers (1.3) and are connected thereto by stretchable sieve liner strips (3), for two sequential transverse carriers, the transverse carrier closer to the feeding side (A) being higher than the subsequent transverse carrier, which is closer to the discharge side (B), and the sifting device having at least two sections, in which the height difference between the centers of gravity of two sequential transverse carriers (1.3, 2.3) is greater in the particular feeding-side section than in the discharge-side section, wherein the second transverse carrier (2.3) are connected to one another in their end regions via receiving parts (2.4) mounted on the sieve box (1) and the supplementary oscillation system (2) thus formed is pivotably mounted around a pendulum axle (2.2).

2. (canceled).

3. The sifting device according to claim 1, wherein the receiving parts (2.4), are mounted on the sieve box (1) via elastic elements.

4. The sifting device according to claim 3, characterized in that the elastic elements are spring elements (5e).

5. The sifting device according to claim 3, wherein the elastic elements are leaf springs (5b).

6. The sifting device according to claim 1, wherein receiving parts (2.4), mounted on the sieve box (1) via hinge rods (7c), which are hingedly mounted on the sieve box (1), additional spring elements (5f) are provided which connect the receiving parts (2.4) to the sieve box (1) and are positioned on the faces of the receiving parts (2.4) and act essentially in the axial direction of the receiving parts.

7. The sifting device according to claim 1, wherein the receiving parts (2.4), are mounted on the sieve box (1) via spacer elements (7a, 7b), which are displaceably mounted on curved guide elements (8), which are connected fixed to the sieve box (1).

8. (canceled).

9. The sifting device according to claim 6, wherein the guiding of the distance elements (7a) along the guide elements (8) is supported by spring elements, which act between the spacer elements (7a, 7b) and the sieve box (1).

10. The sifting device according to claim 1, wherein the second transverse carriers (2.3) are connected to two receiving parts (2.4), which are attached via pendulum odds (2.1) to a pendulum axle (2.2), which is mounted in a support device (1.4), which is connected fixed to the sieve box (1).

11. The sifting device according to claim 10, wherein the pendulum arms (2.1) are connected to the sieve box (1) via spring elements (5a).

12. The sifting device according to claim 1, wherein as the oscillation exciter (4), either an unbalanced drive having a single unbalanced weight or a double unbalanced drive having opposed unbalanced weights (unbalanced exciter) and/or two opposed unbalanced motors or a magnetic oscillating drive is mounted on the sieve box (1) and/or an eccentric drive is mounted between the sieve box (1) and the supplementary oscillation system (2).
